(19) United States
(12) Patent Application Publication
(10) Pub. No.: US 2023/0259666 A1
(43) Pub. Date: Aug. 17, 2023

(54) METHOD AND APPARATUS FOR DETERMINING SPEECH PRIVACY POTENTIAL BETWEEN ADJACENT ROOMS

(71) Applicant: DIRTT ENVIRONMENTAL SOLUTIONS LTD., Calgary (CA)

(72) Inventor: Michael Iannone, Seattle, WA (US)

(21) Appl. No.: 18/169,072

(22) Filed: Feb. 14, 2023

Related U.S. Application Data
(60) Provisional application No. 63/310,002, filed on Feb. 14, 2022.

(51) Int. Cl. G06F 30/13; G06F 21/62

(52) U.S. Cl. CPC G06F 30/13; G06F 21/6245; G06F 2119/10

(57) ABSTRACT

An apparatus and method for determining speech privacy can include deriving a room adjacency matrix based on a building design, model, or floor layout. Using class values or other values representing a degree of sound transmission or attenuation through the walls and ceilings a sound level (e.g., measured in decibels) of speech transmitted from one room to the next can be compared to the background noise levels. Speech privacy can be provided when the transmitted speech between adjacent rooms is less than the background noise. Choices of wall and/or ceiling construction and materials may be modified when the determined speech privacy fails to satisfy the target values. In a building information modeling (BIM) application, the class values for ceilings and walls can be automated based on attributes defined for wall and ceiling objects defined within the BIM application.

### CROSS-REFERENCE TO RELATED APPLICATIONS

The present application claims the benefit of priority to U.S. Provisional Application No. 63/310,002, filed Feb. 14, 2022, entitled “Method and Apparatus for Determining Speech Privacy Potential Between Adjacent Rooms,” the entire content of which is incorporated herein by reference.

### BACKGROUND OF THE INVENTION

### 1. Technical Field

The present invention relates generally to a method and apparatus for determining a speech privacy potential, and more particularly to using a building floor plan and/or computer-aided design or drafting software to determine a speech privacy potential between respective rooms in a building.

### 2. Background and Relevant Art

As computerized systems have increased in popularity, so have the range of applications that incorporate computational technology. Computational technology now extends across a broad range of applications, including a wide range of productivity and entertainment software. Indeed, computational technology and related software can now be found in a wide range of generic applications that are suited for many environments, as well as fairly industry-specific software.

One such industry that has employed specific types of software and other computational technology increasingly over the past few years is that related to building and/or architectural design. In particular, architects and interior designers (“or designers”) use a wide range of computer-aided design (CAD) software or building information modeling (BIM) software (i.e., “architectural design software applications”) for designing the aesthetic as well as functional aspects of a given residential or commercial space. For example, a designer might use a CAD or BIM program to design a building or

Docket No. 16196.250 part of a building, and then utilize drawings or other information from that program to order or manufacture building components.

One particular benefit that is offered by modern CAD and BIM software is the ability to see a three-dimensional rendering of an architectural design. This can provide tremendous value to designers and/or clients who wish to visualize a design before starting the actual building process. For example, in at least one conventional system, a user may be able to view on a computer screen a completely rendered office building. The user may be able to navigate within the three-dimensional renderings such that the user can view different perspectives and locations throughout the design.

While three-dimensional renderings can provide a user with a general idea regarding a final product, conventional three-dimensional renderings suffer for several shortcomings. For example, even when BIM software allows a user to visualize the aesthetics for certain material and fabrication choices for walls and ceilings, the BIM software can fail to provide a user with an appreciation of the acoustic qualities of the rooms being rendered. More particularly, the BIM software fails to provide a metric representing the degree of privacy a particular room has vis-à-vis listeners in adjacent or neighboring rooms or spaces.

Accordingly, there are a number of problems in the art that can be addressed.

### BRIEF SUMMARY OF THE INVENTION

Implementations of the present invention can comprise systems, methods, and apparatuses configured to obtain or generate an adjacency matrix that represent which rooms are adjacent in a floor plan or a design of a building including a plurality of rooms, and to assign an identification handle indicating which wall of one or more walls separates the adjacent rooms. Implementations further include obtaining background noise levels corresponding to the respective rooms of the plurality of rooms, and retrieving values of an acoustic attenuation corresponding to the respective rooms of the plurality of rooms. In addition, implementations include retrieving values of a sound transmission corresponding to the respective walls of the one or more walls, and determining a value for a speech privacy indicator that represents a decibel level below which speech in an adjacent room becomes unintelligible.

In certain implementations, the present invention comprises systems, methods, and apparatuses configured to compare the determined speech privacy indicator to a target speech privacy indicator for respective rooms of the plurality of rooms. When for a given pair of adjacent rooms, the determined speech privacy indicator is less than the target speech privacy indicator, the implementations include changing an attribute of the wall between the given pair of adjacent rooms and/or an attribute of one or more ceilings of the given pair of adjacent rooms, and repeating the steps of (1) retrieving values of an acoustic attenuation corresponding to the given pair of adjacent rooms; (2) retrieving values of sound transmission corresponding to the given pair of adjacent rooms; and (3) determining an updated value for the speech privacy indicator between the given pair of adjacent rooms.

In certain implementations, the present invention can comprise systems, methods, and apparatuses configured such that changing the attribute of the wall includes that the attribute is a material of the wall, a thickness of the wall, or a construction of the wall.

In certain implementations, the present invention can comprise systems, methods, and apparatuses configured to display a qualitative indicator representing the speech privacy indicator based on the value for the speech privacy indicator;

In certain implementations, the present invention can comprise systems, methods, and apparatuses configured such that the qualitative indicator is selected from a group of speech privacy descriptors comprising poor, fair, good, and excellent.

In certain implementations, the present invention can comprise systems, methods, and apparatuses configured such that changing the attribute of the wall further includes which of the wall between the given pair of adjacent rooms and the one or more ceilings provides the least acoustic dampening between pair of adjacent rooms. And the implementation changes the attribute of the wall when the wall provides the least acoustic dampening, and changes the attribute of the one or more ceilings when the one or more ceilings provide the least acoustic dampening.

In certain implementations, the present invention can comprise systems, methods, and apparatuses configured such that determining the value for the speech privacy indicator includes combining the background noise levels with a lesser of a ceiling acoustic class and a sound transmission class. Further, the ceiling acoustic class represent an attenuation of sound traveling between adjacent rooms through the respective ceilings of the adjacent rooms, and the sound transmission class represent an attenuation of sound traveling between adjacent rooms through the wall between the adjacent rooms. The value for the speech privacy indicator corresponds to a decibel value of speech in a first of the adjacent rooms that is intelligible in a second of the adjacent rooms.

In certain implementations, the present invention can comprise systems, methods, and apparatuses configured to use a building information modeling (BIM) application to obtain the adjacency matrix by retrieving the values of the acoustic attenuation corresponding to the respective rooms, and retrieving the values of the sound transmission corresponding to the respective walls. The BIM application, in response to user inputs, provides room objects, wall objects, and ceiling objects, each of the room objects, wall objects, and ceiling objects having respective attributes, and each of the room objects, wall objects, and ceiling objects interacting with other objects of the BIM application by passing information among the room objects, wall objects, and ceiling objects.

In certain implementations, the present invention can comprise systems, methods, and apparatuses configured such that attributes of the wall objects include one or more material types and one or more thicknesses, and, for a given wall object, the BIM application retrieves from memory the values of the sound transmission based on the material types and thicknesses attributes of the given wall object.

In certain implementations, the present invention can comprise systems, methods, and apparatuses configured such that attributes of the ceiling objects include one or more material types and one or more thicknesses, and, for a given ceiling object, the BIM application retrieves from memory the values of the acoustic attenuation based on the material types and thicknesses attributes of the given ceiling object.

In certain implementations, the present invention can comprise systems, methods, and apparatuses configured such that attributes of the room objects include a room type, and, for a given room object, the BIM application retrieves from memory the background noise level based on the room type attribute of the given room object.

In certain implementations, the present invention can comprise systems, methods, and apparatuses configured such that changing the attributes of the wall objects updates the values of the sound transmission provided to the room objects.

In certain implementations, the present invention can comprise systems, methods, and apparatuses configured such that changing the attributes of the ceiling objects updates the values of the acoustic attenuation provided to the room objects.

In certain implementations, the present invention comprises a computer program product comprising one or more physical memory devices having stored thereon computer executable instructions which, when executed at one or more processors of a computing system, cause the computing system to implement a method for determining a speech privacy indicator. The method includes obtaining an adjacency matrix that represent which rooms of a plurality of rooms are adjacent, and assigning an identification handle indicating which wall of one or more walls separates the adjacent rooms; obtaining background noise levels corresponding to the respective rooms of the plurality of rooms; retrieving values of an acoustic attenuation corresponding to the respective rooms of the plurality of rooms; retrieving values of a sound transmission corresponding to the respective walls of the one or more walls; and determining a value for a speech privacy indicator that represents a decibel level below which speech in an adjacent room becomes unintelligible.

In certain implementations, computer program product performs each of the functions discussed for the above-noted systems, methods, and apparatuses.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a flow diagram of an example method for determining speech privacy in accordance with an implementation of the present invention;

FIG. 2A illustrates an example of an adjacency matrix in accordance with an implementation of the present invention;

FIG. 2B illustrates an example of a mapping between a quantitative metric representing speech privacy and a qualitative metric representing speech privacy in accordance with an implementation of the present invention;

FIG. 3 illustrates an example floor for designating background noise (NC levels) in accordance with an implementation of the present invention;

FIG. 4 illustrates an example of sound transmission through a demising wall 230 and through ceilings from a source room to a receiving room in accordance with an implementation of the present invention;

FIG. 5 illustrates an example of determining a quantitative metric representing speech privacy (e.g., the speech privacy potential) based on noise isolation class (NIC) and the background noise (NC level) in accordance with an implementation of the present invention

FIG. 6 illustrates an example of a floor plan with identifiers used in defining an adjacency matrix in accordance with an implementation of the present invention;

FIG. 7 illustrates an example of part of an adjacency matrix in accordance with an implementation of the present invention;

FIG. 8 illustrates an example of data structure used to define a wall in accordance with an implementation of the present invention; and

FIG. 9 illustrates another flowchart of a series of acts in a method for determining speech privacy in accordance with an implementation of the present invention.

### DETAILED DESCRIPTION OF THE PREFERRED EMBODIMENTS

The present invention extends to systems, methods, and apparatuses that determine a sound privacy based on a designated arrangement of rooms and wall configurations. For example, when used with a building information modeling (BIM) application, the sound privacy can be determined based on a model of a building, thereby mitigating the cost and labor of retrofitting a building when speech privacy falls below a minimum requirement. In particular, implementations of the present invention use adjacency matrices and parameters for the wall, ceilings, and rooms to determine a decibel level below which speech in an adjacent room becomes unintelligible. For example, speech privacy between two rooms can be given by the decibel value derived by combining/summing the background noise level (NC level) expressed in decibels for the receiving room with the lesser of the sound transmission class (STC) of the wall between the two rooms and the ceiling acoustic class (CAC) of ceilings between the two rooms. Speech having a decibel value less than the speech privacy value will generally be below the background noise level, generally ensuring privacy. When a higher degree of privacy is desired, a commensurate safety factor can be included in the speech-privacy determination.

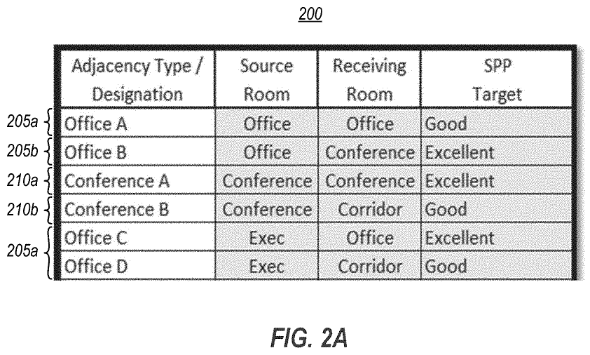

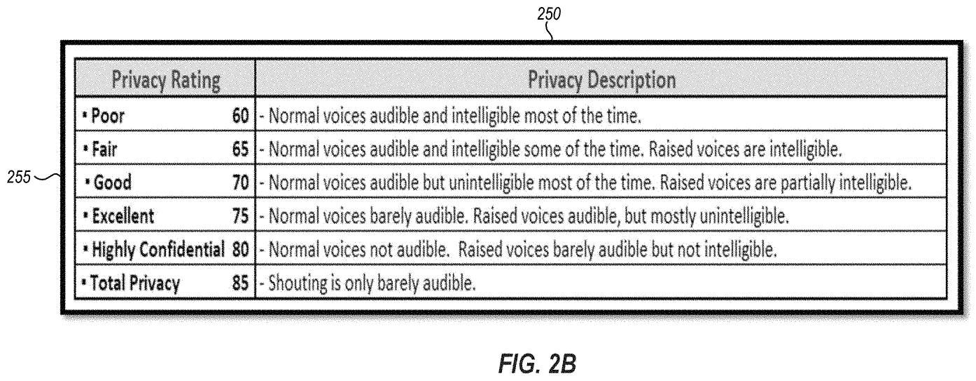

For example, as will be understood from the present description and claims, the speech-privacy determination can be performed by a BIM application. The BIM application can use spatial information regarding which rooms are separated by which walls to automatically determine a room adjacency matrix. For example, the BIM application may be implemented using object-oriented programing. Wall objects defining the walls can have attributes, such as materials and their thicknesses, that can be used to look up, calculate, or otherwise retrieve from memory values for the sound transmission class (STC) of the walls. Further, ceiling objects defining the ceilings can have attributes, such as materials and their thicknesses that can be used to look up, calculate, or otherwise retrieve from memory values for the ceiling acoustic class (CAC) of the walls. The room objects can have attributes from which the background noise level (NC level) can be estimated. For example, rooms assigned the attribute of “conference room” (e.g., FIG. 2A, 210a, 210b) may be assigned an NC level in the range of 30 decibels (dB) to 35 dB. Alternatively or additionally, the NC levels for respective rooms can be assigned by a user.

Acoustic satisfaction in a built environment is a common priority. Acoustic satisfaction may be evaluated by how much conversation can be understood from adjacent spaces. The speech privacy potential (SPP) metric provides a simple yet comprehensive way to both set targets and evaluate construction. SPP is a site specific, single number that is arrived by adding the level of the background noise (referred to as NC and measured in decibels: dB) to the noise isolation class (NIC). The NIC is the field performance of a wall and ceiling assembly, and it is usually about 5 points below the lowest rated component. The SPP is derived by adding the amount of background noise to the amount sound attenuation provided by the walls and ceiling.

Advantageously, determining and updating the speech privacy early and often in the design of a building can be used to avoid situations where a design is almost finalized (or worse already built) when it is discovered that the design fails to provide adequate speech privacy. Thus, speech privacy is not an afterthought, but can be one of several factors (including cost, aesthetics, energy efficiency, etc.) being for which a building design is being optimized during the designing of the building layout. Generally, higher acoustic attenuation is associated with higher construction costs. By determining speech privacy, a designer is better able to provide a virtual estimate of construction costs while maintaining acoustic targets. Additionally, designer can avoid the error of inefficiently using resources to provide more acoustic isolation where such is not required.

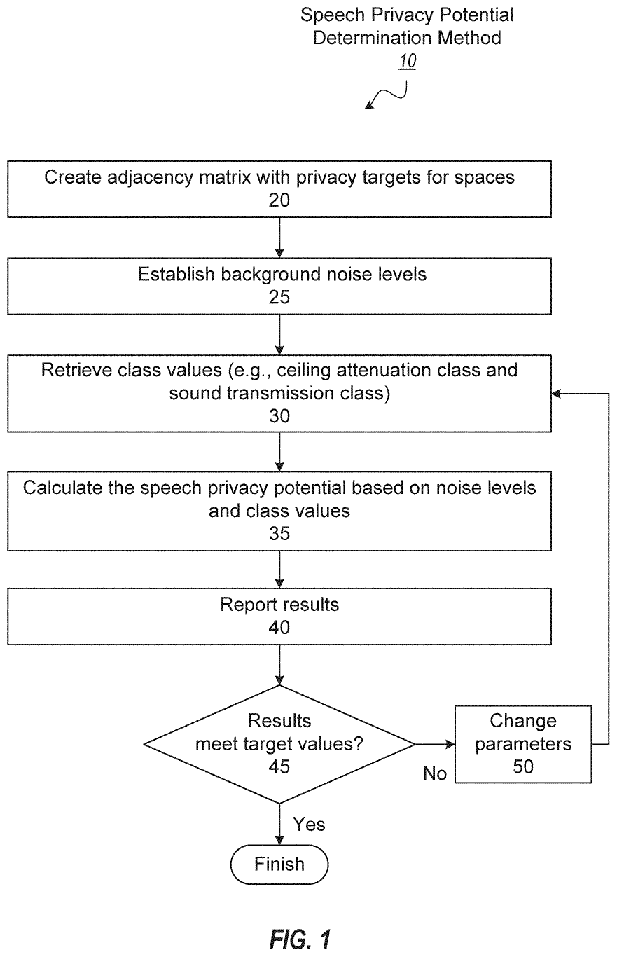

Reference is first made to FIG. 1, which shows a flow diagram of a method for determining a value of speech privacy. In step 20 of method 10, an adjacency matrix is created with privacy targets for respective room and spaces contemplated for a building design. The privacy target is the minimum desired privacy level for each type of adjacency. FIG. 2A illustrates an example of an adjacency matrix 200 that provides target values for speech privacy potential between adjacent rooms. For an adjacency type “Office A” (similar with “Office D”) (205a), the source room is another office and the receiving room is another office. The speech privacy potential (SPP) target for the adjacency type “Office A” 205 is set to the qualitative target “good.” Similarly, FIG. 2A shows that for other types of rooms, such as “Conference Room A” (210a) or “Conference Room B” (210b), the user can also set similar SPP values, as desired.

FIG. 2B shows a chart 250 for mapping qualitative targets to quantitative targets. One will appreciate this chart is a non-limiting example, and other mappings and arrangements or targets may be used. For example, the qualitative target “good” (255) maps to a quantitative target of 70 dB. That is an SPP value of 70 or greater satisfies a qualitative target of “good.”

Referring again to FIG. 2A, for an adjacency type “Office B” (similar with “Office C”) (205b)—in which the source room is an office and the receiving room is a conference room—the SPP target is set to “excellent.” In general, these settings can be determined by customer preferences. Additionally, the adjacency matrix may be revised and some of the SPP targets relaxed, such as in the case of when there is no solution that both 1) satisfies the SPP targets, and 2) is within the customer's budget.

Returning to FIG. 1, in step 25 of method 10, background noise levels are established. Background noise (i.e., the NC level) plays a significant role in determining if the SPP target will be met because the determined SPP value is based on reducing speech from adjacent rooms below the background noise. Thus, background noise is a significant component for determining construction requirements and their costs. Based on an SPP approach, a very quiet space (i.e., low background noise) requires more sound dampening between rooms (e.g., more expensive construction) to achieve a privacy target. On the other hand, an NC level that is too high can impact the ability to converse in a conference setting or impact the use of electronic conferencing technology.

In certain embodiments, background noise (NC) levels are established first, and then the target wall STC and the ceiling CAC ratings are determined based on the established background noise (NC) levels. The NC level can be measured, accounting for normal activity and HVAC noise levels. In spaces with low NC levels, the NC level can be adjusted by utilizing properly tuned sound masking. In certain embodiments, the tuning of sound masking post occupancy can play a significant role. Optimizing the frequency and volume of the sound masking keeps the environment comfortable without adding more sound than necessary.

Alternatively or additionally, to address the issue of lower background noise than desired, walls with higher STC values and/or ceilings with higher CAC values can be used. The low background noise may also be addressed by adding bulkheads. However, so doing will also increase the cost of construction, and may diminish flexibility of the construction.

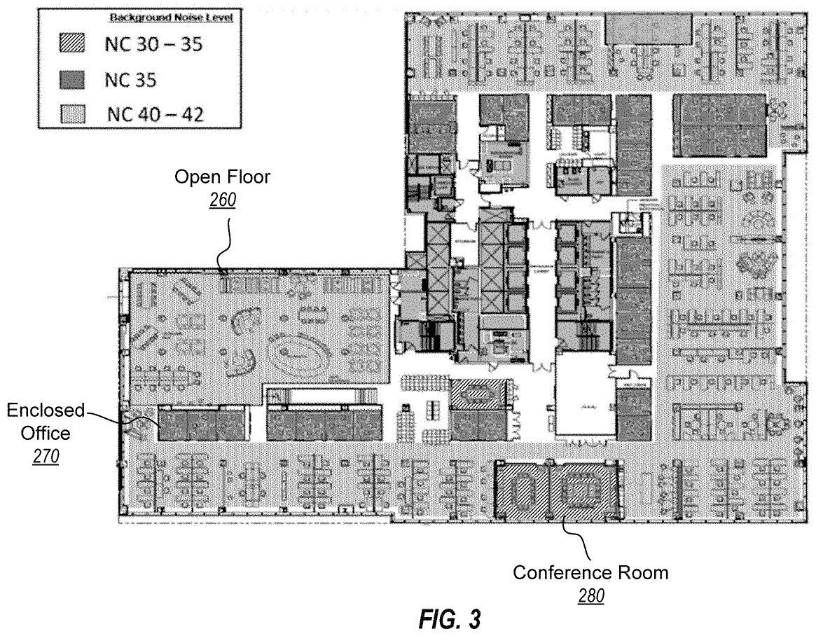

FIG. 3 illustrates an example floor plan in which the NC level in the open floor space 260 is set between 40-42 dB; the NC level in the conference rooms 280 (see also 210a/b, FIG. 2A) is set between 30-35 dB; and the NC level in the offices 270 (see also 205a/b, FIG. 2A is set to 35 dB. Generally, it is considered best practice to net set the NC level above 42 dB. However, in waiting rooms and circulation corridors the NC level can be set as high as 45 dB without adverse consequences.

Returning to FIG. 1, in step 30 of method 10, the ceiling attenuation class (CAC) values for the ceilings and the sound transmission class (STC) for the walls are obtained. For example, these values can be entered by a user, or a BIM application can retrieve these values from a database or calculate these values. The lowest rated construction component will limit the performance of the fully constructed assembly. For example, increasing the wall's STC value is not impactful if the ceiling's CAC value is lower because the ceiling's CAC value is what is keeping the noise isolation class (NIC) of the fully constructed assembly below target.

Returning to FIG. 1, in step 35 of method 10, using the background noise levels and class values (e.g., the STC and CAC values), the SPP values are calculated for each pair of adjacent rooms. This calculation can be performed incorporating a safety margin to account for the possibility of components performing below their nominal class values. For example, in a first SPP calculation mode, five points (e.g., 5 dB) can be subtracted from the lowest rated element of the assembly (wall or ceiling). It is expected that performance in the field will be lower than in the lab in which the wall and ceiling components were test, and so the method of subtracting five points from the lowest rated element can better indicate what performance can be expected after construction. The value of five points being subtracted is non-limiting, and other values of points can be subtracted to provide the desired safety margin; for example, subtracting 1 point, 10 points, or 15 or more points.

In a second SPP calculation mode, the nominal performance is used in the calculation for the SPP value. That is the formula uses the lowest rating (wall or ceiling) without a deduction for a performance drop from lab to field. This method can be used, e.g., to set standards for specification.

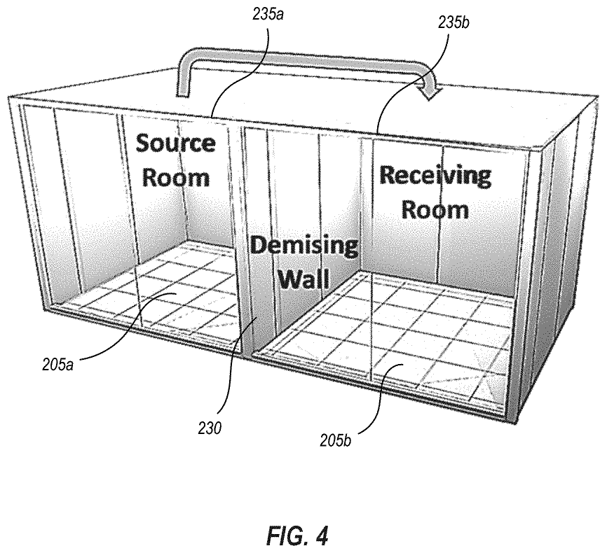

FIG. 4 illustrates a simplified example of speech privacy between two rooms, namely offices 205a/205b. A source room (e.g., office 205a with ceiling 235a) transmits sound to a receiving room (e.g., office 205b with ceiling 235b) through a demising wall 230 and through the ceilings 235a/235b via the ceiling 235a of the source room and the ceiling 235b of the receiving room. The NIC (noise isolation class) can be determined from the STC (sound transmission class) value of the demising wall 230 and the CAC (ceiling acoustic class) values of the intervening ceilings. NIC is the field performance of a wall and ceiling assembly.

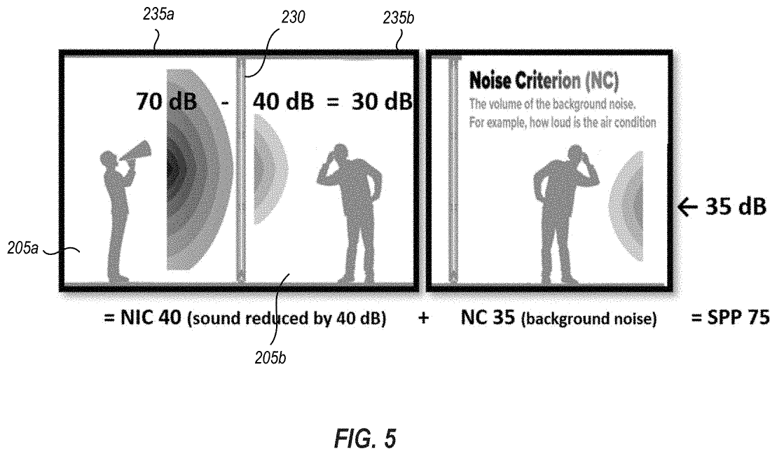

As illustrated in FIG. 5, when the NIC is 40 dB, a volume of speech at 70 dB can be attenuated to 30 dB after being transmitted from the source room 205a to the receiving room 205b. If the volume of the background noise (NC level) in the receiving room is 35 dB, the SPP will be 75 dB, which is the MC value of 40 dB plus the NC level of 35 dB. This means that a speech volume of 75 dB in the source room 205a can, upon transmission to the receiving side 205b, be equal to the background noise and therefor effectively unintelligible. As used herein, the word “unintelligible” is defined to mean that the decibel level of speech is equal to the background noise level, and thus difficult for most to distinguish.

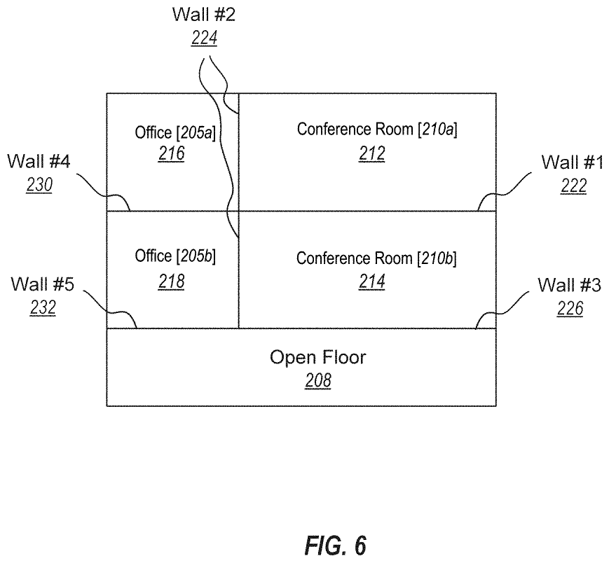

FIG. 6 illustrates an example room layout in which an office 216 is separated from an office 218 by a wall 230. The offices 216 and 218 are respectively separated from conference rooms 222 and 226 by wall 224. Further, office 218 and conference room 214 are separated from an open floor 208 by walls 232 and 226. The walls and rooms are assigned respective identification handles. These handles can be unique alphanumeric identifiers (e.g., the numbers 1, 2, 3, etc.). For example, a user may input the wall numbers or enter wall labels in the adjacency matrix. The user can match the labels on your floor plan of room types. In a BIM (building information modeling) application, the identification handles may be assigned automatically.

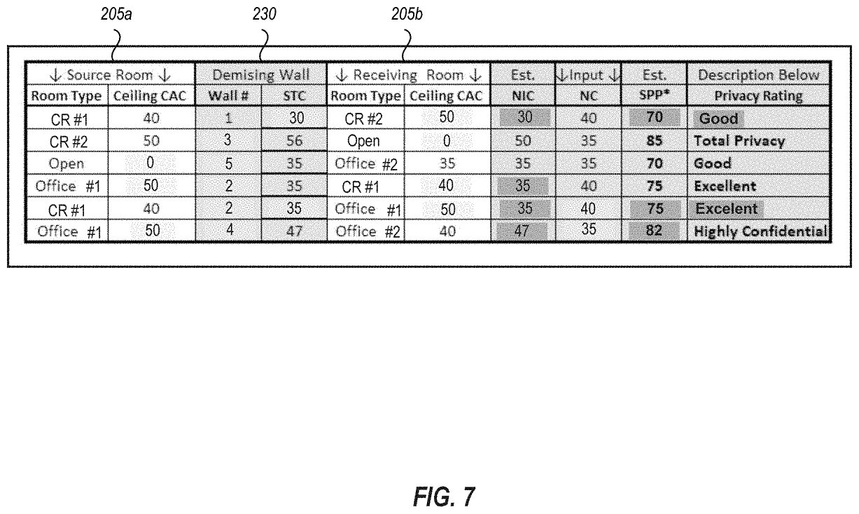

FIG. 7 illustrates an example in which SPP calculations are performed for some of the pairs of adjacent rooms in FIG. 6. In one implementation, the receiving room (205a) and source room (205b) can be defined for each adjacency pair. Then the CAC values and STC values are obtained for the rooms and the demising walls 230 therebetween. From these values the NIC value is determined. The NC level for the receiving room 205b is obtained. The NC level and the CAC and STC values may be entered by a user or may be obtained from a database or lookup table, e.g., when a BIM application is being used to perform the SPP calculation.

In certain embodiments, the user enters the NC levels from an NC target list through a graphical user interface (GUI, not shown). The NC levels can be measurements, or may represent a target that will obtained with the assistance of a consultant and the inclusion of sound masking. Further, the user can select ceiling CAC rating from the dropdown menus in the graphical user interface (GUI). Additionally, the GUI can include a drop-down menu with an options list of commercially available ceiling ratings. Thus, CAC values listed in the drop-down menu will indicate a ceiling's ability to limit sound transfer. If one space has no ceiling, the CAC is 0 (zero). Next, a user enters through the GUI the STC of the suggested wall configuration for each demising condition. The user can use the GUI to show how different wall rating may or may not affect the SPP.

Returning again to FIG. 1, in step 40 of method 10, the results of the SPP calculation are reported to the user. This can be performed by updating a value in the GUI for a field that is labeled SPP (speech privacy potential). For example, in FIG. 7 the column labeled “Est. SPP*” is where the reported values for SPP are provided to the user. In addition to the quantitative value for SPP, a qualitative metric or indicator can be provided to the user, as illustrated in FIG. 7 in the column labeled “Privacy Rating” (see also 255, FIG. 2B). This qualitative metric or indicator can be a descriptor of the privacy rating, such as “poor,” “fair,” “good,” and “excellent.” For example, FIG. 2B provides an example of a mapping between numeric SPP values and corresponding qualitative metrics.

According to one non-limiting embodiment, the qualitative indicator is set to “poor” when a normal voice volume is audible and intelligible most of the time. The qualitative indicator may alternatively be set to “fair” when the normal voice volume is audible but is intelligible only some of the time and when a raised voice volume is intelligible most of the time. In addition, the qualitative indicator may be set to “good” when the normal voice volume is audible but is unintelligible and the raised voice volume is intelligible only some of the time. Furthermore, the qualitative indicator may be set to “excellent” when the normal voice volume is barely audible and the raised voice volume is audible but is intelligible only some of the time. Still further, the qualitative indicator may be set to “highly confidential” when the normal voice volume is not audible and the raised voice volume is barely audible and is unintelligible. Yet still further, the qualitative indicator may be set to “total privacy” when a shouting voice volume is barely audible.

In step 45 of method 10, the determined SPP is compared to the target SPP value. If the target is met, the method 10 is finished. Otherwise, the parameters of the wall (224, 230, or 232, as applicable) or ceiling for the failing adjacency room pair are modified and method 10 is repeated starting at step 30. When the CAC value is less than the STC value, the parameters of the ceiling (235a, 235b, as applicable) can be changed. When the CAC value is greater than the STC value, the parameters of the demising wall (e.g., 230) can be changed. The wall parameters to be changed can include attributes of the wall such as the materials making up the wall, a thickness of the wall, or a construction of the wall. When a BIM application is used, the wall may be represented using a wall object generated using object-oriented programming. The attributes of the wall object may be changed, and the STC value may be updated based on these changed attributes of the wall object.

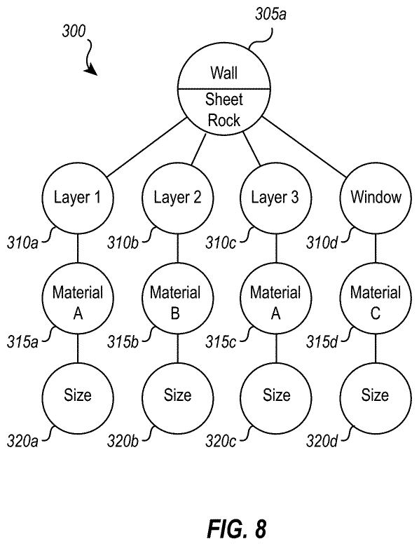

A similar approach may be used for changing the parameters of the ceilings. In particular, FIG. 8 illustrates a data structure of a wall object. Ceiling objects an room objects will be similar data structures, but with different attributes. These various data structures may be created in response to user input. In particular, FIG. 8 shows a data structure 300 having objects 305a, 310a-d, 315a-d, and 320a-d, which are created based on a user selection of a wall in a design space.

For example, in a design software program in accordance with an implementation of the present invention, a user can select a wall icon in a selection area of a user interface, and then “drag and drop” or draw the wall into a specific design space. Upon selection, or shortly thereafter, the design software will also create an initial object 305a for the wall, which contains one or more “Type” and/or “Option” formats. The data from the initial object 305a is propagated throughout additionally created objects in the data structure 300.

For example, FIG. 8 shows that data structure 300 includes a wall object 305a for a wall. The wall object 305a is related to additional child objects 310a-c for each of the three layers of the wall and child object 310d for a window of the wall. The layers objects 310a-c and the window object 310b in turn are related to material objects 315a-d for the material of the layers. Furthermore, child objects 320a-d are related to, and depend from, the material objects 315a-d. Thus, as will be understood in greater detail in the following description, some objects (e.g., object 305a) are parent objects, some objects (e.g., 320a-d) are only child objects, and other objects (e.g., 310a-d, and 315a-d) are both parent and child objects.

For example, as will be understood with more particularity in FIG. 8, each of these objects includes at least a “Type” component, and in the case of parent or parent/child objects, also will include an “Option” component. When an object includes a set of possible options (or “option component”) for a “type,” program code in the given object can be used to determine an appropriate option based any of an attribute of the user's input, and/or based on other reference information from a reference library. The determined option for that object then provides a basis for one or more possible “Type” components for a corresponding child object. For example, with respect to object 315a and object 320a, “Material A” is a determined option for object 315a, and, based on information in the reference library, provides a basis for a type component for object 320a. “Size”, which is a determined option for object 320a, is a possible option for the “Type” component that is based on the determined option of “Material A” in object 315a.

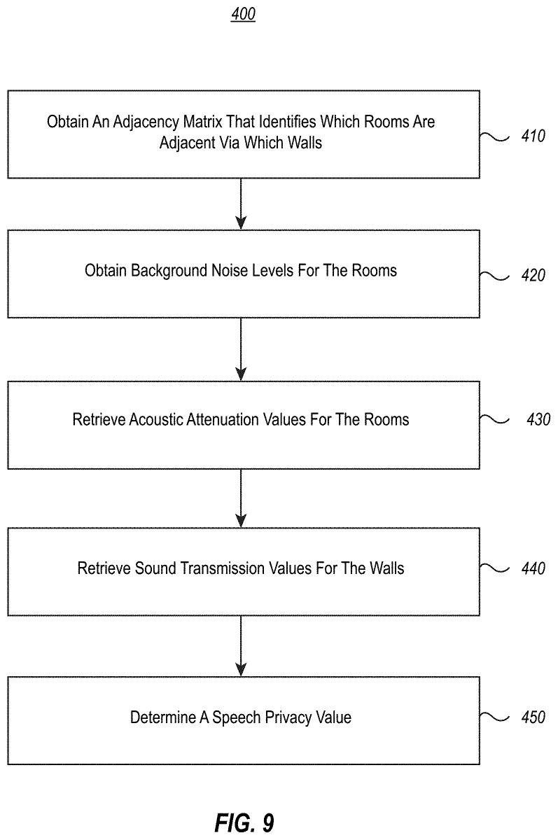

As previously discussed in FIG. 1, implementations of the present invention can also be described in terms of flowcharts of methods comprising a series of acts for accomplishing a particular result. FIG. 9 is another flowchart outlining a series of acts in a computer-implemented method for determining a speech privacy indicator. The acts of FIG. 9 are discussed below with reference to the components and schematics of FIGS. 1-8.

For example, FIG. 9 shows that a computer-implemented method 400 of determining a speech privacy indicator can comprise act 410 of obtaining an adjacency matrix that identifies which rooms are adjacent via which walls. Act 410 includes obtaining an adjacency matrix that represents which rooms of a plurality of rooms are adjacent, and assigning an identification handle indicating which wall of one or more walls separates the adjacent rooms. For example, FIG. 2A illustrates an example adjacency matrix 200, with various different office configurations 205a, 205b, and conference room designations 210a, 210b, etc.

FIG. 9 also shows that method 400 can comprise an act 420 of obtaining background noise levels for the rooms. Act 420 includes obtaining background noise levels corresponding to the respective rooms of the plurality of rooms. For example, FIG. 2A illustrates an SPP Target column in which various qualitative, desired characteristics can be entered, and for which FIG. 2B shows a numerical correlation for the target characteristics.

In addition, FIG. 9 shows that method 400 can comprise an act 430 of retrieving acoustic attenuation values for the rooms. Act 430 includes retrieving values of an acoustic attenuation corresponding to the respective rooms of the plurality of rooms. For example, FIG. 5 shows that when the NIC is 40 dB, a volume of speech at 70 dB can be attenuated to 30 dB after being transmitted from the source room 205a to the receiving room 205b. If the volume of the background noise (NC level) in the receiving room is 35 dB, the SPP will be 75 dB, which is the NIC value of 40 dB plus the NC level of 35 dB.

Furthermore, FIG. 9 shows that method 400 can comprise an act 440 of retrieving sound transmission values for the walls. Act 440 includes retrieving values of a sound transmission corresponding to the respective walls of the one or more walls. For example, FIG. 7 illustrates an example in which SPP calculations are performed for some of the pairs of adjacent rooms in FIG. 6. In one implementation, the receiving room (205 a) and source room (205b) can be defined for each adjacency pair. Then the CAC values and STC values are obtained for the rooms and the demising walls 230 therebetween. From these values the NIC value is determined. The NC level for the receiving room 205b is obtained. The NC level and the CAC and STC values may be entered by a user or may be obtained from a database or lookup table, e.g., when a BIM application is being used to perform the SPP calculation.

Still further, FIG. 9 shows that method 400 can comprise an act 450 of determining a speech privacy value. Act 450 includes determining a value for a speech privacy indicator that represents a decibel level below which speech in an adjacent room becomes unintelligible. For example, as discussed above with respect to FIG. 5, when the NIC is 40 dB, a volume of speech at 70 dB can be attenuated to 30 dB after being transmitted from the source room 205a to the receiving room 205b. If the volume of the background noise (NC level) in the receiving room is 35 dB, the SPP will be 75 dB, which is the NIC value of 40 dB plus the NC level of 35 dB. This means that a speech volume of 75 dB in the source room 205a can, upon transmission to the receiving side 205b, be equal to the background noise and therefor effectively unintelligible. As used herein, the word “unintelligible” is defined to mean that the decibel level of speech is equal to the background noise level, and thus difficult for most to distinguish.

The following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present invention may comprise or utilize a special-purpose or general-purpose computer system that includes computer hardware, such as, for example, one or more processors and system memory, as discussed in greater detail below. The scope of the present invention also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer-implemented method for determining a speech privacy indicator, the method comprising:
obtaining an adjacency matrix that represents which rooms of a plurality of rooms are adjacent, and assigning an identification handle indicating which wall of one or more walls separates the adjacent rooms;
obtaining background noise levels corresponding to the respective rooms of the plurality of rooms;
retrieving values of an acoustic attenuation corresponding to the respective rooms of the plurality of rooms;
retrieving values of a sound transmission corresponding to the respective walls of the one or more walls; and
determining a value for a speech privacy indicator that represents a decibel level below which speech in an adjacent room becomes unintelligible.

2. The method of claim 1, further comprising:
comparing the determined speech privacy indicator to a target speech privacy indicator for respective rooms of the plurality of rooms, and
when, for a given pair of adjacent rooms, the determined speech privacy indicator is less than the target speech privacy indicator
changing an attribute of the wall between the given pair of adjacent rooms and/or an attribute of one or more ceilings of the given pair of adjacent rooms, and
repeating the steps of (1) retrieving values of an acoustic attenuation corresponding to the given pair of adjacent rooms; (2) retrieving values of sound transmission corresponding to the given pair of adjacent rooms; and (3) determining an updated value for the speech privacy indicator between the given pair of adjacent rooms.

3. The method of claim 2, wherein the step of changing the attribute of the wall includes that the attribute is a material of the wall, a thickness of the wall, or a construction of the wall.

4. The method of claim 1, further comprising displaying a qualitative indicator representing the speech privacy indicator based on the value for the speech privacy indicator;

5. The method of claim 4, wherein the qualitative indicator is selected from a group of speech privacy descriptors comprising poor, fair, good, excellent, highly confidential, and total privacy.

6. The method of claim 4, wherein
the qualitative indicator is set to poor when a normal voice volume is audible and intelligible most of the time,
the qualitative indicator is set to fair when the normal voice volume is audible but is intelligible only some of the time and when a raised voice volume is intelligible most of the time,
the qualitative indicator is set to good when the normal voice volume is audible but is unintelligible and the raised voice volume is intelligible only some of the time,
the qualitative indicator is set to excellent when the normal voice volume is barely audible and the raised voice volume is audible but is intelligible only some of the time,
the qualitative indicator is set to highly confidential when the normal voice volume is not audible and the raised voice volume is barely audible and is unintelligible, and
the qualitative indicator is set to total privacy when a shouting voice volume is barely audible.

7. The method of claim 2, wherein
the step of changing the attribute of the wall further includes which of the wall between the given pair of adjacent rooms and the one or more ceilings provides the least acoustic dampening between pair of adjacent rooms,
changing the attribute of the wall when the wall provides the least acoustic dampening, and
changing the attribute of the one or more ceilings when the one or more ceilings provide the least acoustic dampening.

8. The method of claim 1, wherein
the step of determining the value for the speech privacy indicator includes combining the background noise levels with a lesser of a ceiling acoustic class and a sound transmission class, wherein
the ceiling acoustic class represent an attenuation of sound traveling between adjacent rooms through the respective ceilings of the adjacent rooms,
the sound transmission class represent an attenuation of sound traveling between adjacent rooms through the wall between the adjacent rooms, and
the value for the speech privacy indicator corresponds to a decibel value of speech in a first of the adjacent rooms that is intelligible in a second of the adjacent rooms.

9. The method of claim 1, further comprising:
using a building information modeling (BIM) application to obtain the adjacency matrix,
retrieve the values of the acoustic attenuation corresponding to the respective rooms, and
retrieve the values of the sound transmission corresponding to the respective walls, wherein
the BIM application, in response to user inputs, provides room objects, wall objects, and ceiling objects, each of the room objects, wall objects, and ceiling objects having respective attributes, and each of the room objects, wall objects, and ceiling objects interacting with other objects of the BIM application by passing information among the room objects, wall objects, and ceiling objects.

10. The method of claim 9, wherein attributes of the wall objects include one or more material types and one or more thicknesses, and, for a given wall object, the BIM application retrieves from memory the values of the sound transmission based on the material types and thicknesses attributes of the given wall object.

11. The method of claim 9, wherein attributes of the ceiling objects include one or more material types and one or more thicknesses, and, for a given ceiling object, the BIM application retrieves from memory the values of the acoustic attenuation based on the material types and thicknesses attributes of the given ceiling object.

12. The method of claim 9, wherein attributes of the room objects include a room type, and, for a given room object, the BIM application retrieves from memory the background noise level based on the room type attribute of the given room object.

13. The method of claim 12, wherein the room type attribute includes one or more of a corridor, an open floor, an office, a conference room, and an executive office.

14. The method of claim 10, wherein changing the attributes of the wall objects updates the values of the sound transmission provided to the room objects.

15. The method of claim 11, wherein changing the attributes of the ceiling objects updates the values of the acoustic attenuation provided to the room objects.

16. A computer program product comprising one or more physical memory devices having stored thereon computer executable instructions which, when executed at one or more processors of a computing system, cause the computing system to implement a method for determining a speech privacy indicator, wherein the implemented method comprises:
obtaining an adjacency matrix that represent which rooms of a plurality of rooms are adjacent, and assigning an identification handle indicating which wall of one or more walls separates the adjacent rooms;
obtaining background noise levels corresponding to the respective rooms of the plurality of rooms;
retrieving values of an acoustic attenuation corresponding to the respective rooms of the plurality of rooms;
retrieving values of a sound transmission corresponding to the respective walls of the one or more walls; and
determining a value for a speech privacy indicator that represents a decibel level below which speech in an adjacent room becomes unintelligible.

17. The computer program product of claim 16, wherein the implemented method further comprises
comparing the determined speech privacy indicator to a target speech privacy indicator for respective rooms of the plurality of rooms, and
when, for a given pair of adjacent rooms, the determined speech privacy indicator is less than the target speech privacy indicator
changing an attribute of the wall between the given pair of adjacent rooms and/or an attribute of one or more ceilings of the given pair of adjacent rooms, and
repeating the steps of (1) retrieving values of an acoustic attenuation corresponding to the given pair of adjacent rooms; (2) retrieving values of sound transmission corresponding to the given pair of adjacent rooms; and (3) determining an updated value for the speech privacy indicator between the given pair of adjacent rooms.

18. The computer program product of claim 17, wherein the implemented method further comprises that the step of changing the attribute of the wall includes that the attribute is a material of the wall, a thickness of the wall, or a construction of the wall.

19. The computer program product of claim 16, wherein the implemented method further comprises displaying a qualitative indicator representing the speech privacy indicator based on the value for the speech privacy indicator;

20. The computer program product of claim 17, wherein the implemented method further comprises that
the step of changing the attribute of the wall further includes which of the wall between the given pair of adjacent rooms and the one or more ceilings provides the least acoustic dampening between pair of adjacent rooms,
changing the attribute of the wall when the wall provides the least acoustic dampening, and
changing the attribute of the one or more ceilings when the one or more ceilings provide the least acoustic dampening.
